(19) United States
(12) Patent Application Publication
(10) Pub. No.: US 2008/0231048 A1
(43) Pub. Date: Sep. 25, 2008

(54) PNEUMATIC SWIVEL ELBOW

(75) Inventors: Mark Steven Hillis, Tacoma, WA (US); Chuck Stephens, Seattle, WA (US)

Correspondence Address: THE OLLILA LAW GROUP LLC, 2060 BROADWAY, SUITE 300, BOULDER, CO, 80302, US

(73) Assignee: Norgren, Inc., Littleton, CO (US)

(21) Appl. No.: 11/689,965

(22) Filed: Mar. 22, 2007

(51) Int. Cl. F16L 43/00; F16L 27/00

(52) U.S. Cl. 285/179; 285/272

(57) ABSTRACT

A pneumatic swivel elbow is provided according to the invention. The pneumatic swivel elbow includes an internal passage extending through the pneumatic swivel elbow and substantially changing in direction. The pneumatic swivel elbow further includes a male coupling portion formed on one end and adapted to be sealingly inserted into and engaged with a corresponding bore of a mating component and being configured to sealingly rotate within the corresponding bore. The pneumatic swivel elbow further includes a conduit coupling portion formed on a substantially opposite end from the male coupling portion. The conduit coupling portion is configured to sealingly receive a pneumatic conduit and is configured to allow the pneumatic conduit to rotate within the conduit coupling portion.

### BACKGROUND OF THE INVENTION

1. Field of the Invention

The present invention relates to a pneumatic elbow, and more particularly, to a pneumatic swivel elbow.

2. Statement of the Problem

Pneumatic systems, such as pneumatic systems of motor vehicles, are comprised of many different components. One component can be a solenoid that is used to open a valve or valves and regulate the flow of air or other gases. The solenoid requires that various hoses or other conduits be attached so that the solenoid can function.

In the prior art, a hose or other conduit can be connected to a solenoid by a coupling that is screwed into the solenoid or otherwise held in place. The coupling may be required to be an elbow fitting, wherein the elbow allows the hose or other conduit to approach the solenoid at an angle, including at a right angle. An elbow may be necessary due to space limitations or in order to directly or correctly route a conduit.

In the prior art, a pneumatic elbow is typically formed to have threads or other attachment means that affix the elbow to the solenoid or other device. A prior art pneumatic elbow is designed to transition an airflow or other fluid flow from a first direction to a second direction. Consequently, the prior art pneumatic elbow extends a significant distance out away from the mating component.

A prior art pneumatic elbow is not designed to have a low profile, wherein the prior art pneumatic elbow can extend a significant distance from the solenoid. This can lead to difficulties, such as taking up excessive space, interfering with the running of other conduits or lines of a vehicle, more susceptibility to being hit or broken, etc.

U.S. Patent Publication 2003/0019496 to Kopacko et al. shows a respiratory mask that includes a swivel elbow 62 (see FIGS. 1, 3, and 6). The elbow 62 can continuously swivel and conducts air into a mask portion. However, the swivel joint of Kopacko is formed of a pair of flanges that trap a portion of the mask. Kopacko does not include a seal. In addition, the air supply in Kopacko is of a low pressure, wherein the simple flange swivel joint will not allow excessive volume of air to escape, even without any manner of seal. The swivel elbow of Kopacko does not seal and retain pressurized air, as in a pneumatic system.

U.S. Patent Publication 2006/0188122 to Smith discloses a swivel elbow for an earpiece. The elbow features two barbed male connectors for receiving hose ends. One of the male connectors is fixed to a body. A second male connector passes through the body at an angle to the first male connector and can rotate with respect to the body. However, Smith does not disclose a sealingly swiveled second male connector. In addition, the elbow of Smith does not contain gas under pressure and is not air tight. Further, there is no fluid/gas flow through the elbow.

There remains a need in the art for a pneumatic elbow that presents a low profile. There remains a need in the art for a pneumatic elbow that can freely swivel, while presenting a low profile.

### SUMMARY OF THE INVENTION

A pneumatic swivel elbow is provided according to the invention. The pneumatic swivel elbow comprises an internal passage extending through the pneumatic swivel elbow and substantially changing in direction. The pneumatic swivel elbow further comprises a male coupling portion formed on one end and adapted to be sealingly inserted into and removably engaged with a corresponding bore of a mating component and being configured to sealingly rotate within the corresponding bore. The pneumatic swivel elbow further comprises a conduit coupling portion formed on a substantially opposite end from the male coupling portion. The conduit coupling portion is configured to sealingly receive a pneumatic conduit and is configured to allow the pneumatic conduit to rotate within the conduit coupling portion.

A pneumatic swivel elbow is provided according to the invention. The pneumatic swivel elbow comprises an internal passage extending through the pneumatic swivel elbow and substantially changing in direction. The pneumatic swivel elbow further comprises a male coupling portion formed on one end and adapted to be sealingly inserted into and engaged with a corresponding bore of a mating component and being configured to sealingly rotate within the corresponding bore. The pneumatic swivel elbow further comprises a conduit coupling portion formed on a substantially opposite end from the male coupling portion. The conduit coupling portion is configured to sealingly receive a pneumatic conduit and is configured to allow the pneumatic conduit to rotate within the conduit coupling portion. The pneumatic swivel elbow further comprises a bearing face formed adjacent to the male coupling portion and adapted to substantially contact the mating component.

An elbow insertion method for a pneumatic swivel elbow is provided according to the invention. The method comprises positioning a male retainer ring onto a male coupling portion of the pneumatic swivel elbow, with the male retainer ring engaging the male coupling portion, positioning one or more bore seals onto a stepped-down portion of the male coupling portion after the male retainer ring has been positioned, and inserting the male coupling portion onto a corresponding bore of a mating component, wherein the male retainer ring engages with the bore.

### DESCRIPTION OF THE DRAWINGS

The same reference number represents the same element on all drawings. It should be understood that the drawings are not necessarily to scale.

FIG. 1 shows a pneumatic swivel elbow according to an embodiment of the invention.

FIG. 2 shows the pneumatic swivel elbow assembled to a mating component according to an embodiment of the invention.

FIG. 3 is a cross-sectional view of the pneumatic swivel elbow according to an embodiment of the invention.

FIG. 4 is a cross-sectional view of the pneumatic swivel elbow according to an embodiment of the invention.

FIG. 5 shows the pneumatic swivel elbow fully assembled to a mating component according to an embodiment of the invention.

### DETAILED DESCRIPTION OF THE INVENTION

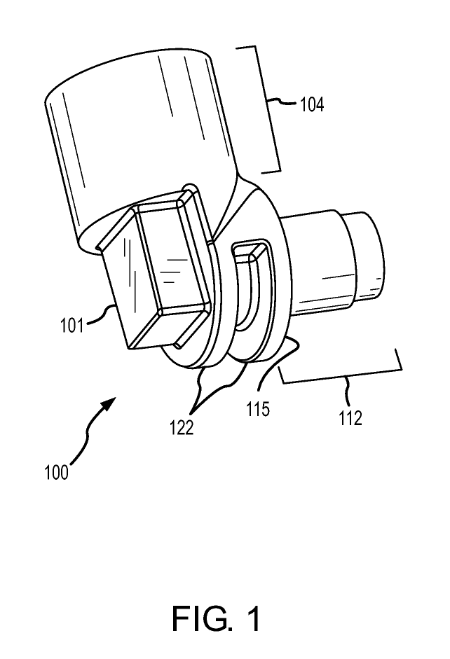

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

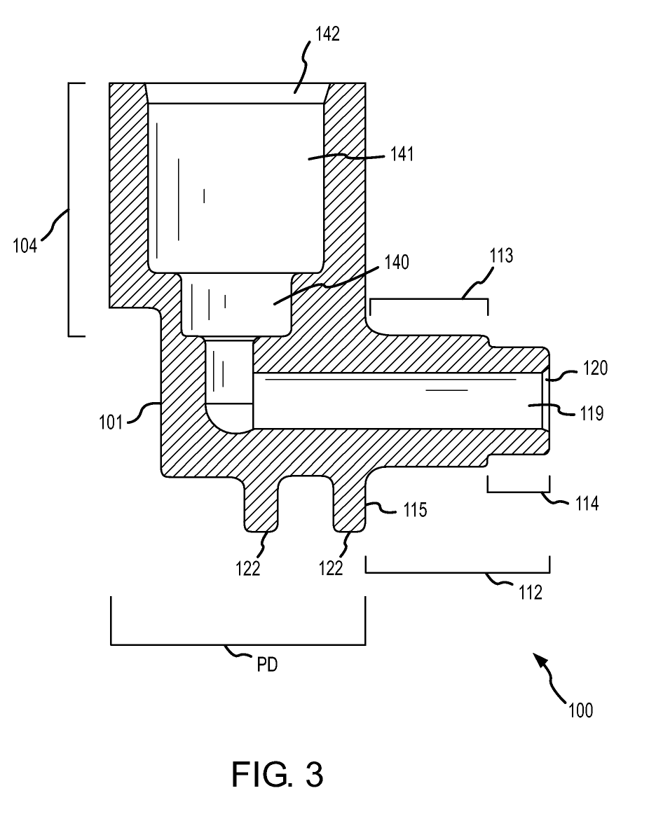

FIG. 1 shows a pneumatic swivel elbow 100 according to an embodiment of the invention. The pneumatic swivel elbow 100 includes a body 101, a conduit coupling portion 104, and a male coupling portion 112. The body 101 further includes an internal passage 119 that extends through the pneumatic swivel elbow 100 (see FIG. 3). The internal passage 119 in one embodiment includes a substantially right angle change in direction. However, it should be understood that the pneumatic swivel elbow 100 can be formed wherein the internal passage 119 includes an angle other than ninety degrees, including angles greater than or less than ninety degrees.

The body 101 in some embodiments includes a rectangular portion that facilitates installation of the pneumatic swivel elbow 100. For example, a wrench or tool can fit to the rectangular portion and can subsequently hold the pneumatic swivel elbow 100 in a desired position.

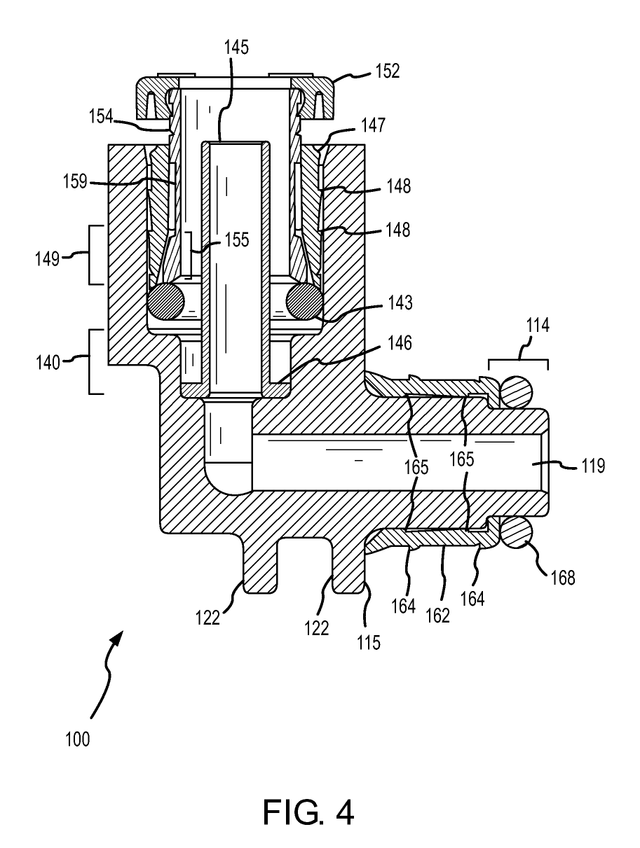

The conduit coupling portion 104 receives a conduit, such as a hose, for example. The conduit can be flexible or rigid. The conduit coupling portion 104 will be discussed below in conjunction with FIG. 4.

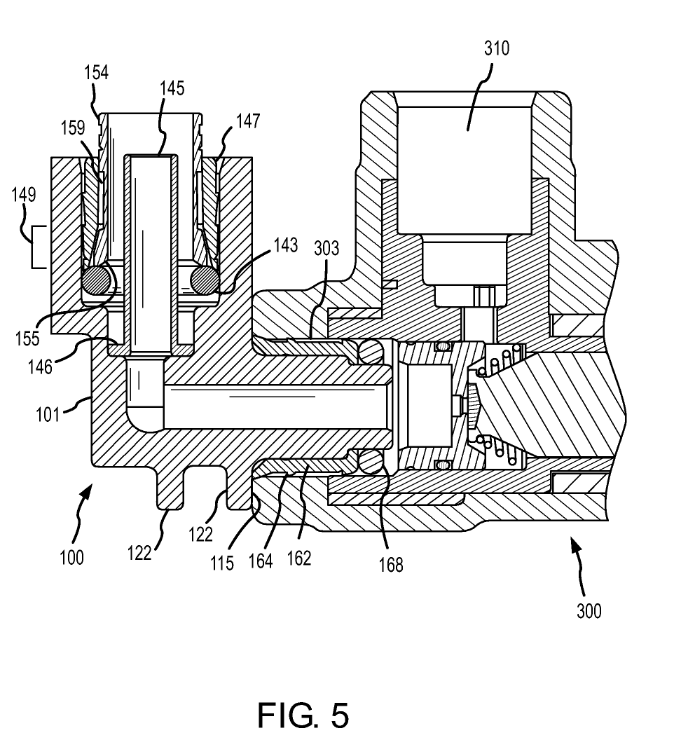

The male coupling portion 112 couples to a corresponding bore or receptacle in a mating component 300, such as in a solenoid, for example. The male coupling portion 112 will be discussed below in conjunction with FIG. 5.

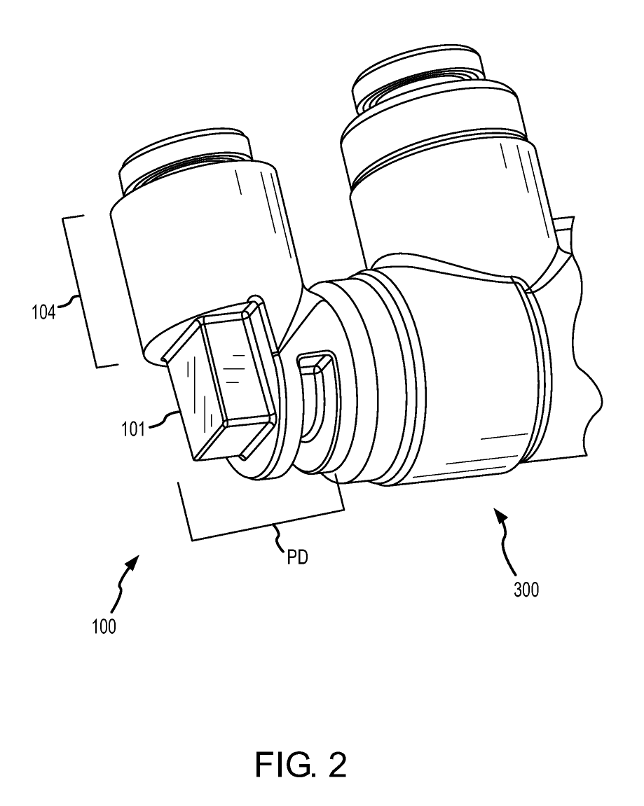

The pneumatic swivel elbow 100 can include a bearing face 115. The bearing face 115 contacts a portion of a mating component 300 (see FIG. 2). The bearing face 115 can consequently ensure proper alignment of the pneumatic swivel elbow 100, wherein the bearing face 115 will not allow the pneumatic swivel elbow 100 to become canted or angled with respect to the mating component 300. In addition, the bearing face 115 will substantially protect the male coupling portion 112 from breaking if a force is placed on the pneumatic swivel elbow 100 at an angle.

The pneumatic swivel elbow 100 can include one or more flanges 122. The flanges 122 extend at least partially from the body 101. The one or more flanges 122 can provide features for gripping the pneumatic swivel elbow 100 when installing the pneumatic swivel elbow 100. In addition, the one or more flanges 122 can provide strength and rigidity to the pneumatic swivel elbow 100. Further, a flange 122 can provide a portion of the bearing surface 115.

The pneumatic swivel elbow 100 can swivel with respect to the mating component 300 when the pneumatic swivel elbow 100 is installed to the mating component 300. The swiveling can be accomplished while maintaining an air or fluid tight seal. The pneumatic swivel elbow 100 can continuously swivel through a full 360 degrees, and not just between preset positions or detents. The pneumatic swivel elbow 100 can seal at any rotational position.

The swiveling is accomplished without having to first loosen an engagement between the pneumatic swivel elbow 100 and the mating component 300. Conversely, the seal is maintained without having to subsequently tighten the engagement between the pneumatic swivel elbow 100 and the mating component 300 after a swiveling operation. The swiveling capability therefore enables flexibility in the installation and/or use of the pneumatic swivel elbow 100.

The pneumatic swivel elbow 100 can comprise a pneumatic component. The pneumatic swivel elbow 100 can conduct a pressurized gas, such as air, for example.

FIG. 2 shows the pneumatic swivel elbow 100 assembled to a mating component 300 according to an embodiment of the invention. The mating component 300 receives the male coupling portion 112 in a corresponding bore 303 (see FIG. 5).

In one embodiment, the mating component 300 comprises a solenoid. However, it should be understood that the bore 303 can be formed in any mating component, and not necessarily a solenoid.

It can be seen from the figure that the pneumatic swivel elbow 100 has a relatively small profile depth (PD). As a result of this small profile depth (PD), the pneumatic swivel elbow 100 is very compact and takes up less space than a conventional elbow. The pneumatic swivel elbow 100 is less likely to block or interfere with the running of other conduits or lines of a motor vehicle. The pneumatic swivel elbow 100 is less likely to be hit and/or damaged by other components of the motor vehicle.

FIG. 3 is a cross-sectional view of the pneumatic swivel elbow 100 according to an embodiment of the invention. The conduit coupling portion 104 includes an inner bore 140 and an outer bore 141. The inner bore 140 is smaller than the outer bore 141. The outer bore 141 can include a flare 142.

The internal passage 119 connects to the inner bore 140 and extends through the pneumatic swivel elbow 100. The internal passage 119 in some embodiments includes a flare 120.

The male coupling portion 112 includes a tube portion 113 and a stepped-down portion 114. The tube portion 113 can be substantially cylindrical. The stepped-down portion 114 is smaller than the tube portion 113.

In the embodiment shown, the pneumatic swivel elbow 100 includes two flanges 122. It can be seen from the figure that one of the flanges 122 forms a portion of the bearing face 115. However, other numbers of flanges can be included.

The profile depth (PD) is a measure of a protrusion distance that the pneumatic swivel elbow 100 extends from the bearing face 115. It can be seen from the figure that the PD is relatively small, given the necessity for the conduit coupling portion 104.

FIG. 4 is a cross-sectional view of the pneumatic swivel elbow 100 according to an embodiment of the invention. The figure shows additional components of the conduit coupling portion 104 and the male coupling portion 112. The conduit coupling portion 104 includes components that enable the pneumatic swivel elbow 100 to removably engage a conduit, such as an air hose, for example. Likewise, the male coupling portion 112 includes components, such as a press-in rotatable retainer mechanism, that enable the pneumatic swivel elbow 100 to engage a mating component 300 including a bore 303, such as a port or outlet of a solenoid, for example.

The conduit coupling portion 104 as shown in the figure is ready to receive a conduit. The conduit coupling portion 104 includes a conduit retainer ring 147, one or more conduit seals 143, a tube support 145, and a collet 154. The collet 154 can further include a collet cap 152 that removably engages the collet 154.

The conduit retainer ring 147 includes one or more teeth 148 that engage the outer bore 141 of the conduit coupling portion 104. The one or more teeth 148 therefore retain the conduit retainer ring 147 in the outer bore 141. The conduit retainer ring 147 further includes an angled face 149. The angled face 149 is located on an inner, lower portion of the conduit retainer ring 147. The angled face 149 interacts with a compression lobe 155 of the collet 154, as discussed below.

The tube support 145 comprises a tube that a conduit fits over. The conduit is forced over the tube support 145 as the conduit is inserted into the conduit coupling portion 104. The tube support 145 prevents the conduit from collapsing or being otherwise deformed. The tube support 145 in some embodiments includes a foot 146 that resides in the inner bore 140. The foot 146 in some embodiments fits into the inner bore 140 with a friction or press fit.

The collet 154 fits into and is retained in the conduit retainer ring 147 and interacts with the tube support 145. As a result, an inserted conduit will be at least partially compressed between the collet 154 and the tube support 145. In addition, the one or more conduit seals 143 can sealingly compress the conduit to the tube support 145.

The one or more conduit seals 143 can comprise any manner of sealing element. In the example given in the figure, the one or more conduit seals 143 comprise an O-ring. The one or more conduit seals 143 are sized to be at least partially compressed between a conduit and the surface of the outer bore 141. The one or more conduit seals 143 are located at an inner end of the outer bore 141.

In some embodiments, the one or more conduit seals 143 have some spaced to move between the collet 154 and the inner end of the outer bore 141. This space allows the one or more conduit seals 143 to move and therefore allows the collet 154 to be inserted and removed from the conduit retainer ring 147.

The one or more conduit seals 143 in one embodiment can slip substantially freely over the conduit. Alternatively, the one or more conduit seals 143 in another embodiment can be at least partially stretched in order to fit over the conduit.

The collet 154 further includes a compression lobe 155 and a flex cut-out 159. The compression lobe 155 interacts with the angled face 149 of the conduit retainer ring 147. When the collet 154 is inserted into the conduit retainer ring 147, the compression lobe 155 is forced inward. However, the compression lobe 155 is allowed to resume a substantially normal, unflexed position in the conduit retainer ring 147 by the angled face 149, wherein the angled face 149 allows the compression lobe 155 to expand substantially back to an uncompressed configuration. For removal, a predetermined amount of force must be placed on the collet 154 for the compression lobe 155 to flex inward and allow the collet 154 to be removed from the conduit retainer ring 147. The angled face 149 therefore retains the compression lobe 155 and the collet 154.

The flex cut-out 159 in some embodiments comprises a thinning or reduction in the material of the collet 154. The flex cut-out 159 therefore allows the compression lobe 155 to flex under a compression force, aiding in both the insertion and removal of the collet 154.

It can be seen from the figure that the compression lobe 155 can contact the one or more conduit seals 143. The collet 154 can therefore be sealed to the outer bore 141 by the one or more conduit seals 143. In addition, the one or more conduit seals 143 can prevent air or other gases from leaking around the conduit retainer ring 147.

The male coupling portion 112 as shown in the figure is ready to be inserted into the corresponding bore 303 in the mating component 300. The male coupling portion 112 includes a male retainer ring 162 and one or more bore seals 168. The male retainer ring 162 and the one or more bore seals 168 can comprise a press-in rotatable retainer mechanism. The one or more bore seals 168 are located between and at least partially compressed between the stepped-down portion 114 and the corresponding bore 303. In the example given in the figure, the one or more bore seals 168 comprise an O-ring.

The one or more bore seals 168 in one embodiment can slip substantially freely over the stepped-down portion 114. Alternatively, the one or more bore seals 168 in another embodiment can be at least partially stretched in order to fit over the stepped-down portion 114.

The male retainer ring 162 slips over and engages the tube portion 113 of the male coupling portion 112. For this purpose, the male retainer ring 162 includes one or more inner teeth 165. The one or more inner teeth 165 engage the tube portion 113. The one or more inner teeth 165 therefore retain the male retainer ring 162 on the tube portion 113.

The male retainer ring 162 further includes one or more outer teeth 164. The one or more outer teeth 164 engage a bore when the male coupling portion 112 is inserted into the bore. The one or more outer teeth 164 engage the bore 303.

FIG. 5 shows the pneumatic swivel elbow fully assembled to the mating component 300 according to an embodiment of the invention. In the figure, the mating component 300 comprises a solenoid. However, it should be understood that the mating component 300 can comprise any manner of component.

The mating component 300 includes a bore 303 that corresponds to the male coupling portion 112. The male coupling portion 112 is inserted into the bore 303, along with the male retainer ring 162 and the one or more bore seals 168. It can be seen from the figure that the one or more outer teeth 164 of the male retainer ring 162 have engaged the bore 303. In addition, the one or more bore seals 168 have been at least partially compressed between the stepped-down portion 114 and the bore 303.

The male coupling portion 112 can be inserted into the bore 303 until the mating component 300 contacts the bearing face 115. The bearing face 115 acts as an insertion stop. As previously discussed, a flange 122 can form a portion of the bearing face 115, as can be seen from the figure. As a result, the pneumatic swivel elbow 100 is sealingly engaged to the mating component 300. The bearing face 115 ensures proper alignment. The bearing face 115 doesn't allow the pneumatic swivel elbow 100 to flex with respect to the mating component and therefore prevents breakage of either component.

Likewise, the conduit coupling portion 104 is ready to receive a conduit. To install the conduit, the conduit is simply pushed down into the conduit coupling portion 104. The conduit passes over the tube support 145 and is forced inside the collet 154. The conduit is pushed down until it passes the one or more conduit seals 143. The conduit can be pushed down until it contacts the foot 146 of the tube support 145.

In some embodiments, the male coupling portion 112 can further fit to another port 310 of the mating component 300. In this manner, a conduit can be connected to any port or bore of the mating component 300.

It should be understood that the pneumatic swivel elbow 100 can swivel in the bore 303. The male coupling portion 112 will retain a seal even as the pneumatic swivel elbow 100 is rotated. The pneumatic swivel elbow 100 can swivel continuously, and is not limited to specific regions or limited by stop or detent devices. Rotation of the pneumatic swivel elbow 100 with respect to the mating component 300 will not loosen the engagement of the male coupling portion 112 with the bore 303.

Both the conduit coupling portion 104 and the male coupling portion 112 achieve a substantially fluid tight seal, such as an air tight seal. The seals are maintained by the pneumatic swivel elbow 100. The seals are maintained even when the associated conduit flexes or moves. The seals are maintained when the pneumatic swivel elbow swivels or rotates with respect to the mating component 300.

Advantageously, the pneumatic swivel elbow 100 according to the invention can be inserted into the corresponding bore 303 without the need for tools. Likewise, a conduit can be inserted into the pneumatic swivel elbow 100 without tools. Further, the pneumatic swivel elbow 100 can be easily and quickly installed.

What is claimed is:

1. A pneumatic swivel elbow, comprising:
an internal passage extending through the pneumatic swivel elbow and substantially changing in direction;
a male coupling portion formed on one end and adapted to be sealingly inserted into and engaged with a corresponding bore of a mating component and being configured to sealingly rotate within the corresponding bore; and
a conduit coupling portion formed on a substantially opposite end from the male coupling portion, with the conduit coupling portion being configured to sealingly receive a pneumatic conduit and being configured to allow the pneumatic conduit to rotate within the conduit coupling portion.

2. The elbow of claim 1, with the pneumatic swivel elbow further comprising one or more flanges.

3. The elbow of claim 1, with the male coupling portion further comprising a bearing face adapted to substantially contact the mating component.

4. The elbow of claim 1, with the male coupling portion including a press-in rotatable retainer mechanism.

5. The elbow of claim 1, with the male coupling portion including a press-in rotatable retainer mechanism comprising:
a tube portion substantially coaxial with the internal passage;
a stepped-down portion extending over at least a portion of the tube portion and being smaller than the tube portion;
a male retainer ring configured to fit over the tube portion and engage the tube portion and adapted to engage the corresponding bore; and
one or more bore seals adapted to be at least partially compressed between the stepped-down portion and the corresponding bore, with the one or more bore seals substantially sealing the male coupling portion to the corresponding bore.

6. The elbow of claim 5, with the male retainer ring further comprising:
one or more outer teeth that engage the corresponding bore; and
one or more inner teeth that engage the tube portion.

7. The elbow of claim 1, with the conduit coupling portion comprising:
an outer bore adapted to receive a retainer ring and one or more conduit seals;
an inner bore that is smaller than the outer bore, with the inner bore being adapted to receive a tube support;
a tube support including a base, with the base being configured to fit into the inner bore and adapted to receive a conduit at least partially over the tube support;
the one or more conduit seals located in the outer bore and adapted to sealingly compress the conduit against the tube support;
a conduit retainer ring configured to fit into and affix to the outer bore; and
a collet located at least partially inside and coaxial with the conduit retainer ring, wherein when inserted into the outer bore, the conduit retainer ring and the collet are adapted to at least partially compress the conduit onto the tube support.

8. The elbow of claim 7, with the conduit retainer ring further comprising one or more teeth that engage the outer bore of the conduit coupling portion.

9. The elbow of claim 7, with the conduit retainer ring further comprising an angled face and with the collet further comprising:
a compression lobe ring, wherein when the collet is inserted substantially into the conduit retainer ring the compression lobe ring is allowed to move a predetermined outward distance by the angled face; and
a flex cut-out that allows the compression lobe ring to flex substantially inward and outward.

10. A pneumatic swivel elbow, comprising:
an internal passage extending through the pneumatic swivel elbow and substantially changing in direction;
a male coupling portion formed on one end and adapted to be sealingly inserted into and engaged with a corresponding bore of a mating component and being configured to sealingly rotate within the bore;
a conduit coupling portion formed on a substantially opposite end from the male coupling portion, with the conduit coupling portion being configured to sealingly receive a pneumatic conduit and being configured to allow the pneumatic conduit to rotate within the conduit coupling portion; and
a bearing face formed adjacent to the male coupling portion and adapted to substantially contact the mating component.

11. The elbow of claim 10, with the pneumatic swivel elbow further comprising one or more flanges.

12. The elbow of claim 10, with the male coupling portion including a press-in rotatable retainer mechanism.

13. The elbow of claim 10, with the male coupling portion including a press-in rotatable retainer mechanism comprising:
a tube portion substantially coaxial with the internal passage;
a stepped-down portion extending over at least a portion of the tube portion and being smaller than the tube portion;
a male retainer ring configured to fit over the tube portion and engage the tube portion and adapted to engage the corresponding bore; and
one or more bore seals adapted to be at least partially compressed between the stepped-down portion and the corresponding bore, with the one or more bore seals substantially sealing the male coupling portion to the corresponding bore.

14. The elbow of claim 13, with the male retainer ring further comprising:
one or more outer teeth that engage the corresponding bore; and
one or more inner teeth that engage the tube portion.

15. The elbow of claim 10, with the conduit coupling portion comprising:
an outer bore adapted to receive a retainer ring and one or more conduit seals;
an inner bore that is smaller than the outer bore, with the inner bore being adapted to receive a tube support;
a tube support including a base, with the base being configured to fit into the inner bore and adapted to receive a conduit at least partially over the tube support;
the one or more conduit seals located in the outer bore and adapted to sealingly compress the conduit against the tube support;
a conduit retainer ring configured to fit into and affix to the outer bore; and
a collet located at least partially inside and coaxial with the conduit retainer ring, wherein when inserted into the outer bore, the conduit retainer ring and the collet are adapted to at least partially compress the conduit onto the tube support.

16. The elbow of claim 15, with the conduit retainer ring further comprising one or more teeth that engage the outer bore of the conduit coupling portion.

17. The elbow of claim 15, with the conduit retainer ring further comprising an angled face and with the collet further comprising:
a compression lobe ring, wherein when the collet is inserted substantially into the conduit retainer ring the compression lobe ring is allowed to move a predetermined outward distance by the angled face; and
a flex cut-out that allows the compression lobe ring to flex substantially inward and outward.

18. An elbow insertion method for a pneumatic swivel elbow, the method comprising:
positioning a male retainer ring onto a male coupling portion of the pneumatic swivel elbow, with the male retainer ring engaging the male coupling portion;
positioning one or more bore seals onto a stepped-down portion of the male coupling portion after the male retainer ring has been positioned; and
inserting the male coupling portion onto a corresponding bore of a mating component, wherein the male retainer ring engages with the bore.

19. The method of claim 18, with the one or more bore seals fitting substantially freely over the stepped-down portion.

20. The method of claim 18, with the one or more bore seals being at least partially stretched to fit over the stepped-down portion.

21. The method of claim 18, with the pneumatic swivel elbow further comprising one or more flanges.

22. The method of claim 18, with the male coupling portion further comprising a bearing face adapted to substantially contact the mating component.

23. The method of claim 18, with the male coupling portion including a press-in rotatable retainer mechanism.

24. The method of claim 18, with the male coupling portion including a press-in rotatable retainer mechanism comprising:
a tube portion substantially coaxial with the internal passage;
a stepped-down portion extending over at least a portion of the tube portion and being smaller than the tube portion;
a male retainer ring configured to fit over the tube portion and engage the tube portion and adapted to engage the corresponding bore; and
one or more bore seals adapted to be at least partially compressed between the stepped-down portion and the corresponding bore, with the one or more bore seals substantially sealing the male coupling portion to the corresponding bore.

25. The method of claim 24, with the male retainer ring further comprising:
one or more outer teeth that engage the corresponding bore; and
one or more inner teeth that engage the tube portion.

26. The method of claim 18, with the conduit coupling portion comprising:
an outer bore adapted to receive a retainer ring and one or more conduit seals;
an inner bore that is smaller than the outer bore, with the inner bore being adapted to receive a tube support;
a tube support including a base, with the base being configured to fit into the inner bore and adapted to receive a conduit at least partially over the tube support;
the one or more conduit seals located in the outer bore and adapted to sealingly compress the conduit against the tube support;
a conduit retainer ring configured to fit into and affix to the outer bore; and
a collet located at least partially inside and coaxial with the conduit retainer ring, wherein when inserted into the outer bore, the conduit retainer ring and the collet are adapted to at least partially compress the conduit onto the tube support.

27. The method of claim 26, with the conduit retainer ring further comprising one or more teeth that engage the outer bore of the conduit coupling portion.

28. The method of claim 26, with the conduit retainer ring further comprising an angled face and with the collet further comprising:
a compression lobe ring, wherein when the collet is inserted substantially into the conduit retainer ring the compression lobe ring is allowed to move a predetermined outward distance by the angled face; and
a flex cut-out that allows the compression lobe ring to flex substantially inward and outward.
